(19) United States
(12) Patent Application Publication
(10) Pub. No.: US 2016/0016322 A1
(43) Pub. Date: Jan. 21, 2016

(54) BLADE WITH A VARYING CUTTING ANGLE

(71) Applicant: THE REGENTS OF THE UNIVERSITY OF CALIFORNIA, Oakland, CA (US)

(72) Inventors: M. Saif Islam, Davis, CA (US); Logeeswaran Veerayah Jayaraman, Davis, CA (US)

(73) Assignee: The Regents of the University of California, Oakland, CA (US)

(21) Appl. No.: 14/772,067

(22) PCT Filed: Mar. 14, 2014
(86) PCT No.: PCT/US14/28831

§ 371 Date: Sep. 1, 2015

Related U.S. Application Data
(60) Provisional application No. 61/792,876, filed on Mar. 15, 2013.

(51) Int. Cl. B26B 21/56; B26B 21/40; B26B 21/60

(52) U.S. Cl. CPC B26B 21/56; B26B 21/60; B26B 21/4087

(57) ABSTRACT

A blade is described. This blade includes a substrate having two surfaces that meet at a cutting edge of the blade. At a given location along a length of the cutting edge, the two surfaces are at an angle with respect to one another. Moreover, angles between the two surfaces are different at at least two locations along the length of the blade. In particular, the angles between the two surfaces may vary along the length of the blade. Furthermore, the blade may include islands having top surfaces positioned at other locations along the length of the blade. These islands may protrude above the cutting edge to protect skin of a user when the blade is used to cut hair. In addition, the islands may include fluidic channels that provide a fluid (such as air or a lubricant) at the top surfaces of the islands when the blade is used.

### BACKGROUND

1. Field

The present disclosure generally relates to a cutting instrument. More specifically, the present disclosure relates to a blade having a cutting edge with a cutting angle that varies along a length of the blade.

2. Related Art

Existing blades are often fabricated using metal. However, these existing metal blades are often expensive to fabricate, use processing chemicals that can negatively impact environment and have limited durability or operating life because of cutting-edge degradation (such as micro-chipping and burr formation) and oxidation-induced damage (such as rusting of the blades).

These limitations of existing metal blades often result in difficulties during use, such as skin and tissue irritation, as well as and bleeding, for example, in shaving applications. One approach for improving the overall shaving experience is to include multiple blades in a cutting device, such as a shaver. However, the use of multiple blades increases the complexity and cost of the shaver. In addition, with four or more blades per shaver, this approach has already reached diminishing returns.

Hence, what is needed is a blade without the problems described above.

### SUMMARY

The described embodiments include a blade. This blade includes a substrate having two surfaces that meet at a cutting edge of the blade, where, at a given location along a length of the cutting edge, the two surfaces are at an angle with respect to one another. Moreover, angles between the two surfaces are different at at least two locations along the length of the blade.

For example, the angles may vary periodically along the length of the blade.

In some embodiments, the blade includes islands having top surfaces positioned at other locations along the length of the blade, where the islands protrude above the cutting edge to protect skin of a user when the blade is used to cut hair. Moreover, the islands may include fluidic channels that provide a fluid at the top surfaces of the islands when the blade is used. For example, the fluid may include a lubricant and/or air.

Furthermore, the blade may include a coating on at least one of the two surfaces configured to prevent fracture of the substrate. This coating may also assist or facilitate the cutting process. Alternatively or additionally, the blade may include another coating on at least one of the two surfaces that indicates a wear status of the blade. For example, the other coating may provide a visible indication when the blade exceeds its operating life, such as a change in the color of the other coating.

Additionally, the substrate may include a monitoring and feedback mechanism (such as anelectronic or an optical monitor) that senses: a presence of moisture and/or a hardness of a material the blade is cutting.

Note that, at the given location, the angle may change from the cutting edge to a base of the substrate that is distal from the cutting edge.

In some embodiments, the angles are associated with one angle category in a set of N potential angle categories for the blade, where N is an integer.

Moreover, the cutting edge may include a cutting pattern along the length of the blade.

Furthermore, a position of the cutting edge may deviate from a plane to define a two-dimensional spatial pattern.

Another embodiment provides a cutting device that includes a handle and the blade. For example, the blade may be rigidly or remateably mechanically coupled to the handle. In some embodiments, the cutting device includes a motor that rotates the blade around an axis of the motor.

Another embodiment provides a method for cutting an object. During this method, a cutting edge of the blade is positioned in at least partial mechanical contact with a surface of the object, where the blade includes the substrate having the two surfaces that meet at the cutting edge of the blade. Moreover, at the given location along the length of the cutting edge, the two surfaces are at the angle with respect to one another, and the angles between the two surfaces are different at at least the two locations along the length of the blade. Then, the blade is displaced along the surface of the object while maintaining the at least partial mechanical contact.

### BRIEF DESCRIPTION OF THE FIGURES

FIG. 1 is a block diagram illustrating a side view of a blade at a location in accordance with an embodiment of the present disclosure.

FIG. 2 is a block diagram illustrating a side view of the blade in FIG. 1 at a different location in accordance with an embodiment of the present disclosure.

FIG. 3 is a block diagram illustrating a side view of the blade in FIGS. 1 and 2 in accordance with an embodiment of the present disclosure.

FIG. 4 is a block diagram illustrating a top view of the blade in FIGS. 1 and 2 in accordance with an embodiment of the present disclosure.

FIG. 5 is a block diagram illustrating a top view of a blade in accordance with an embodiment of the present disclosure.

FIG. 6 is a block diagram illustrating a cutting device in accordance with an embodiment of the present disclosure.

FIG. 7 is a flow diagram illustrating a method for cutting an object in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

Embodiments of a blade, a cutting device that includes the blade, a method for cutting an object, and a technique for fabricating the blade are described. This blade includes a substrate having two surfaces that meet at a cutting edge of the blade. At a given location along a length of the cutting edge, the two surfaces are at an angle with respect to one another. Moreover, angles between the two surfaces are different at at least two locations along the length of the blade. In particular, the angles between the two surfaces may vary along the length of the blade. Furthermore, the blade may include islands having top surfaces positioned at other locations along the length of the blade. These islands may protrude above the cutting edge to protect skin of a user when the blade is used to cut hair. In addition, the islands may include fluidic channels that provide a fluid (such as air or a lubricant) at the top surfaces of the islands when the blade is used.

The blade may be fabricated using semiconductor-process techniques. This may allow the blade to be fabricated on a semiconductor wafer using batch processing techniques (e.g., 20,000 instances of the blade may be fabricated on a wafer prior to singulation). This approach may allow the cost of the blade to be reduced significantly. In addition, the use of semiconductor-process techniques may allow a wide variety of blade structures and/or configurations, which may improve the performance of the blade. For example, the blade may have longer life, or may be less likely to cut or irritate the skin of an individual who uses the blade to shave their hair. In addition, the use of semiconductor-process techniques may improve the reproducibility and reliability of the blade, and may result in a high-yield fabrication process, which may also significantly reduce the cost of the blade.

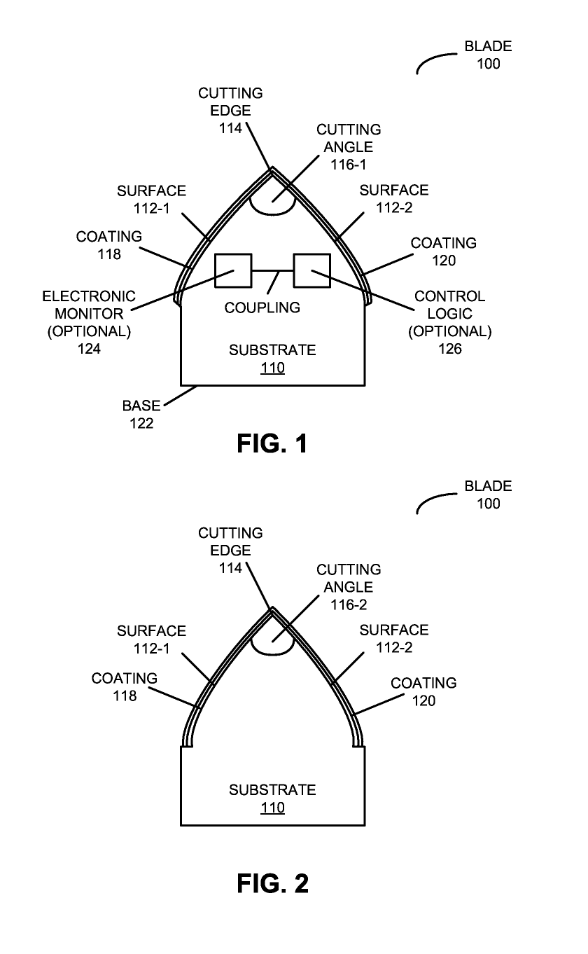

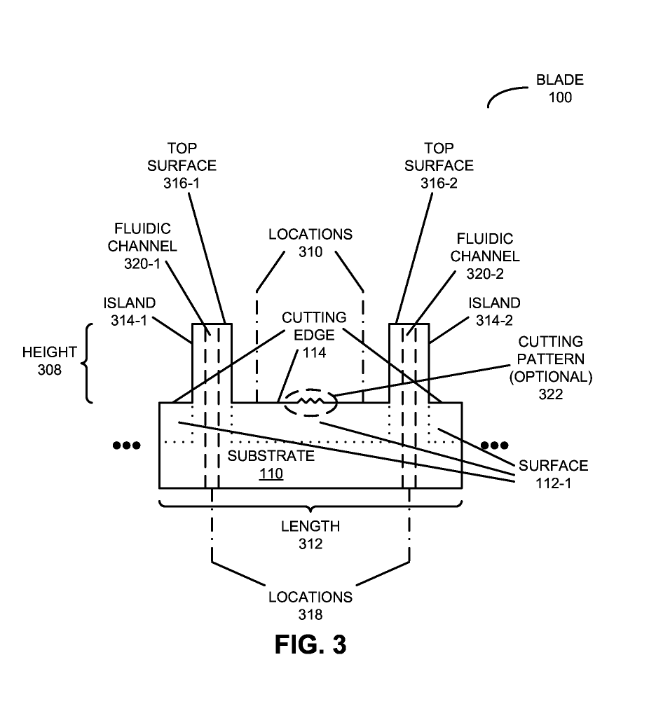

We now describe embodiments of a blade. FIG. 1 presents a block diagram illustrating a side view of a blade 100 at one of locations 310 (FIG. 3). This blade includes a substrate 110 having surfaces 112 that meet at a cutting edge 114. (Note that, while surfaces 112 are illustrated as being symmetric about a vertical axis through cutting edge 114, in other embodiments an asymmetric configuration of surfaces 112 about such a vertical axis is used.) At a given location along a length of cutting edge 114, surfaces 112 are at an angle (θ) 116-1 (which is sometimes referred to as a ‘cutting angle’) with respect to one another. Moreover, as shown in FIG. 2, which presents a block diagram illustrating a side view of blade 100, angle 116-2 may be different at one of locations 310 (FIG. 3) than the location illustrated in FIG. 1.

The variation in the angle is further shown in FIG. 3, which presents a block diagram illustrating a side view of a blade 100. In particular, the angles between the surfaces 112 are different at at least two locations 310 along length 312 of blade 100. For example, the angles may vary periodically along length 312 of blade 100. By varying the angles along length 312, the cutting properties of blade 100 can be varied, such as from sharp (or an efficient cutting edge) to non-sharp and back again.

This capability may also allow blades to be fabricated for different types of applications or, in the case of shaving body hair, individuals having hair with different characteristics. These individuals may be classified into a finite number of classes and suitable blades may be fabricated for each of these classes. Thus, angles 116 may be associated with one angle category in a set of N potential angle categories for blade 100, where N is an integer (such as five).

In some embodiments, blade 100 includes islands 314 having top surfaces 316 positioned at locations 318 along length 312 of blade 100. In particular, except at the ends of blade 100, islands 314 may be positioned between adjacent segments of cutting edge 114. Islands 314 may protrude by a height 308 above cutting edge 114 to protect skin of a user (and, more generally, an object being cut by blade 100) when blade 100 is used to cut hair. Note that islands 314 may prevent the user's skin from contacting cutting edge 114 and, more generally, may reduce friction/stick-slip behavior between blade 100 and the user's skin. Moreover, islands 314 may include fluidic channels 320 that provide a fluid at top surfaces 316 when blade 100 is used. For example, the fluid may include: air, shaving cream, a gel, aftershave, a moisturizer, a disinfectant, a lubricant, a cleaning fluid and/or a pharmacological agent. (Alternatively, at least some of islands 314 may be recessed below the cutting surface to provide fluid.) Furthermore, cutting edge 114 may include an optional cutting pattern 322 along length 312 of blade 100, such as: saw-tooth profile, a plain-tooth profile, an M-tooth profile, a great-American-tooth profile, a champion-tooth profile, a lance-tooth profile, a perforated-lance-tooth profile, or a straight-edge profile.

Referring back to FIG. 1, blade 100 may include a coating 118 disposed on at least one of surfaces 112 configured to prevent fracture of substrate 110. Alternatively or additionally, blade 100 may include coating 120 disposed on at least one of the surfaces 112 that indicates a wear status of blade 100. For example, coating 120 may provide a visible indication when blade 100 exceeds its operating life, such as a change in the color of coating 120 after a maximum number of uses of blade 100. When the color of coating 120 changes (and, more generally, when a performance of blade 100 changes), it may indicate that it is time to replace blade 100. In some embodiments, the thickness of coating 120 is selected to provide the color based on optical interference. As coating 120 wears and the thickness changes, the color produced by the optical interference may change.

Additionally, surfaces 112 may be textured to reduce or prevent dust and/or other shaving or cutting products from sticking to blade 100. For example, the texture may enhance a surface roughness of surfaces 112. This texture may also facilitate self-cleaning of blade 100.

Note that, at one of locations 310 (FIG. 3), the angle may change from cutting edge 114 to a base 122 of substrate 110 that is distal from cutting edge 114. For example, the profile of blade 100 may be: a planar-concave shape, a beveled shape, a wedge shape or a chisel shape. This tapering or change in profile may increase the mechanical robustness of blade 100.

In some embodiments, substrate 110 includes an optional monitoring mechanism 124 (such as an electronic and/or an optical monitor) that senses: a presence of moisture, a shear force and/or a hardness of a material that blade 100 is cutting. Furthermore, substrate 110 may include optional control logic 126 that is electrically or optically coupled to optional monitoring mechanism 124, and that adjusts the amount of fluid discharged by fluidic channels 320 (FIG. 3) based on the output of optional monitoring mechanism 124. In some embodiments, substrate 110 includes an electrical element (such as a heater), and/or an optical element (such as a light source) that removes hair in conjunction with or independently of blade 100. Additionally, substrate 110 may also include electrodes, microfluidic and/or light-guiding channels to facilitate: tissue stimulation, optical monitoring, surgery and/or biological tissue removal.

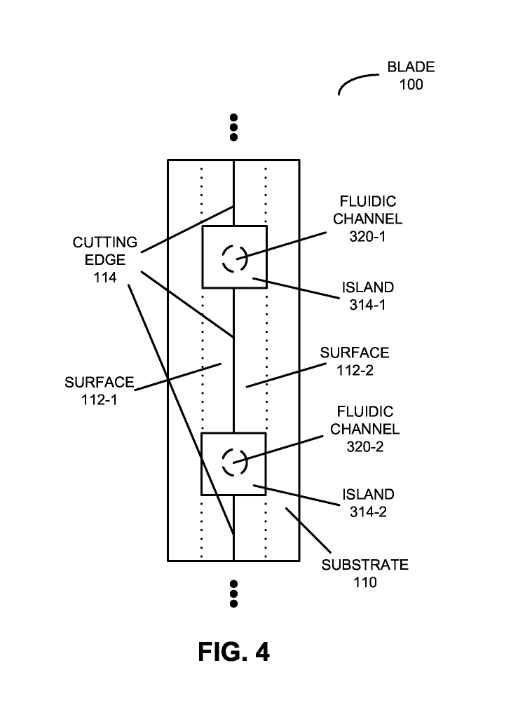

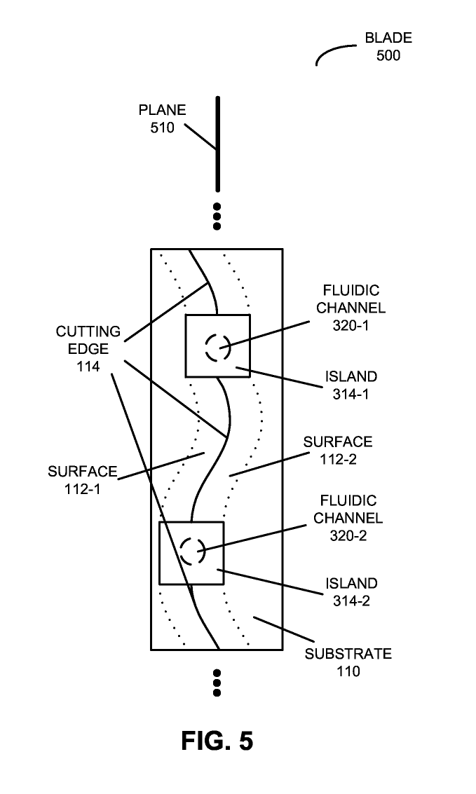

Cutting edge 114 of blade 100 may be along a straight line, i.e., along a dimension. This is shown in FIG. 4, which presents a top view of blade 100. Alternatively, as shown in FIG. 5, which presents is a block diagram illustrating a top view of a blade 500, a position of cutting edge 114 may deviate from a plane 510 to define a two-dimensional (2D) spatial pattern, such as a 2D meandering spatial pattern (e.g., a sine-wave spatial pattern).

The embodiments of the blade may be used in a wide variety of applications, such as: surgery (e.g., cataract surgery, tissue removal, and/or bone removal), shaving of body hair (or hair removal), preparation of a biological specimen, paint removal, and industrial cutting. For example, one or more instances of the blade may be capable of simultaneously removing multiple layers of a tissue, a material or a specimen.

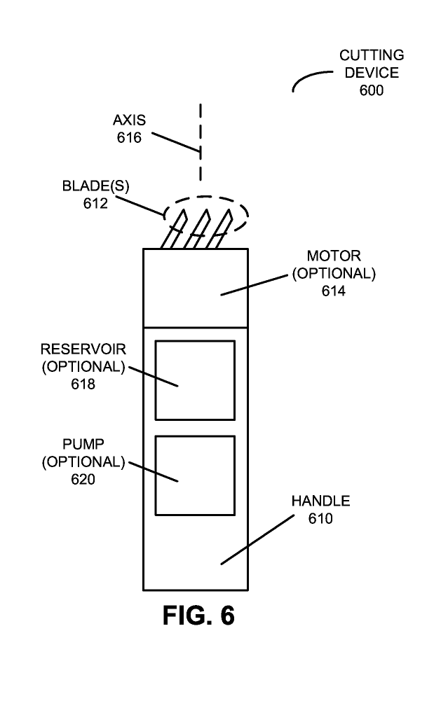

Note that the applications of the blade may be manual or may include the use of a motor that displaces the blade (such as an electric shaver). This is shown in FIG. 6, which presents a block diagram illustrating a cutting device 600 that includes a handle 610 and one or more blades 612. For example, the one or more blades 612 may be rigidly or remateably mechanically coupled to handle 610. In some embodiments cutting device 600 includes a 2D array that includes multiple instances of blades that are spatially offset from each other along a direction perpendicular to planes of the instances of the blade (e.g., by using a stretchable tape). In some embodiments, cutting device 600 includes an optional motor 614 (and, more generally, a mechanical displacement device) that rotates the one or more blades 612 around an axis 616 of optional motor 614 or vibrates the one or more blades 612 along a direction. Thus, cutting device 600 may include an electric shaver. Alternatively, cutting device 600 may be a surgical blade. Note that cutting device 600 may include an optional reservoir 618 and/or an option pump 620 that provides fluid via internal channels or tubes to fluidic channels 320 (FIG. 3).

We now describe techniques for fabricating the blade. The blade may be fabricated using semiconductor-process techniques on a mother substrate. In particular, the blade may be etched in the substrate (e.g., using isotropic and/or anisotropic etching) and optionally coated with a high hardness material (such as boron nitride). Each instance of the blade may have a high aspect ratio (with a larger height than width) and a sharp edge that can be used for shaving or cutting. The geometry of the blade (as well as the fluidic channels and/or the fluid) may be tailored for a particular user experience. One or more instances of the blade may be transfer printed into an epoxy or a polymer (such as benzocyclobutene) at an arbitrary angle, and then singulated or separated from the mother substrate (e.g., by fracturing the blade from the mother substrate at an etch-defined ‘break’ or fracture point and, more generally, using a release mechanism). The angular position of the one or more instances of the blade may be modified as needed (so that each instance of the blade is positioned at a predefined angle such as 30°), and the polymer with the one or more instances of the blade may be cured (e.g., using ultraviolet light). Sharp edges may be optionally formed on the instances of the blade after singulation (alternatively, the sharp edges may be formed prior to singulation), and the instances of the blade in the polymer may be packaged into a cutting device for subsequent use.

Note that one or more types of impurities or dopants (such as metals, alloys, metal-semiconductors and/or ceramics) may be implanted into the substrate or to the cutting edge(s) to: enhance hardness, reduce brittleness, and/or increase flexibility of the cutting edges. In conjunction with the flexibility provided by the aforementioned fabrication technique, the cutting angle, cutting-edge profile, blade size, sharpness and/or physical properties of the blade may be tailored to optimize the shaving or cutting experience. Thus, the blade may be designed to reduce or eliminate bleeding and skin irritation, or the sharpness reduction that can occur with use. Because the blade may not be subject to oxidation (e.g., it may not rust), it may be more durable than existing metal blades, and may have a longer shelf or use life.

In an exemplary embodiment, the substrate is a <1 0 0> silicon wafer. After an oxide/silicon nitride mask is disposed on a top surface of the silicon wafer, etch pits may be produced by etching using potassium hydroxide. These etch pits may have an angle relative to the top surface of 54.7°. For example, the etch pits may be 213 μm deep and may have a width of 300 μm.

Then, the outer surface of the silicon wafer may be oxidized again, and a photoresist may be spin coated onto one side of the etch pits. This may allow the mask to be etched away from this side of the etch pits.

Next, deep reactive-ion etching (DRIE) may be used to fabricate the high-aspect ratio structures. For example, there may be a series of blades in the shape of walls or ridges every 500 μm. A given blade may have an angled top surface (at an angle of 34.3°), a height of 485-490 μm, and a width of 150 μm (however, the width can range from nanometers to thousands of micrometers). The residual silicon-wafer thickness between the pillars may be 10-15 μm, so the blades can be singulated after being pressed into a polymer (i.e., during the transfer printing). Note that a silicon wafer that is cut and polished at an angle theta (θ) with respect to a <1 0 0>silicon wafer, will produce blades with angled top surface at an angle of (35.3°-θ), thereby offering opportunities for tuning the angle of the cutting edges. Moreover, as noted previously, the blades may have an arbitrary orientation and/or an arbitrary number of blades per package.

The blade may be fabricated using an additive or positive process (i.e., a material-deposition process) and/or a subtractive or negative process (i.e., a material-removal process). For example, the process may include: sputtering, plating, isotropic etching, anisotropic etching, wet etching, dry etching, transfer printing, a photolithographic technique and/or a direct-write technique. Additionally, these processes may utilize a wide variety of materials, including: a semiconductor, metal, glass, sapphire, a ceramic, an organic material (such as plastic, e.g., the blade may be fabricated using injection-molded plastic), a ceramic material, and/or silicon dioxide. Therefore, referring back to FIG. 1, substrate 110 may include silicon or a material or a compound other than silicon, such as: gallium nitride, aluminum nitride, boron nitride, alumina, diamond, diamond-like carbon, silicon carbide, a ceramic, a metal, a semiconductor, and/or an alloy. In some embodiments, blade 100 is a passive component. Consequently, if the substrate is a silicon wafer, a low-quality wafer with impurities may be used to decrease the cost of the instances of the blade.

The preceding embodiments may include fewer components or additional components. Although these embodiments are illustrated as having a number of discrete items, these embodiments are intended to be functional descriptions of the various features that may be present rather than structural schematics of the embodiments described herein. Consequently, in these embodiments two or more components may be combined into a single component, and/or a position of one or more components may be changed. While the preceding embodiments illustrated a blade fabricated using photolithographic techniques that has a varying angle (between surfaces 112 in FIG. 1) as a function of the location along a cutting edge. However, in other embodiments the blade has a single angle as a function of location along the cutting edge.

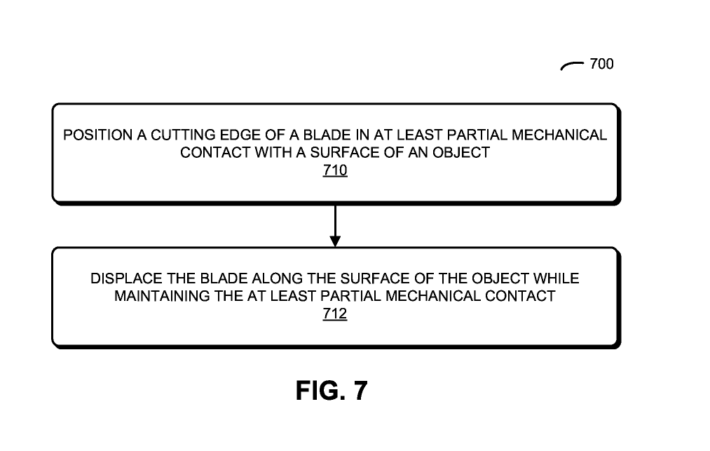

We now describe embodiments of the method. FIG. 7 presents a flow diagram illustrating a method 700 for cutting an object, which may be performed using an embodiment of the blade. During this method, a cutting edge of the blade is positioned in at least partial mechanical contact with a surface of the object (operation 710), where the blade includes the substrate having the two surfaces that meet at the cutting edge of the blade. Moreover, at the given location along the length of the cutting edge, the two surfaces are at the angle with respect to one another, and the angles between the two surfaces are different at at least the two locations along the length of the blade. Then, the blade is displaced along the surface of the object while maintaining the at least partial mechanical contact (operation 712).

In some embodiments of method 700, there are additional or fewer operations. Moreover, the order of the operations may be changed, and/or two or more operations may be combined into a single operation.

In the preceding description, we refer to ‘some embodiments.’ Note that ‘some embodiments’ describes a subset of all of the possible embodiments, but does not always specify the same subset of embodiments.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. A blade, comprising:
a substrate having two surfaces that meet at a cutting edge of the blade, wherein, at a given location along a length of the cutting edge, the two surfaces are at an angle with respect to one another; and
wherein angles between the two surfaces are different at at least two locations along the length of the blade.

2. The blade of claim 1, wherein the angles vary periodically along the length of the blade.

3. The blade of claim 1, wherein the blade further comprises islands having top surfaces positioned at other locations along the length of the blade;
wherein the islands protrude above the cutting edge to protect skin of a user when the blade is used to cut hair; and
wherein the islands include fluidic channels configured to provide a fluid at the top surfaces of the islands when the blade is used.

4. The blade of claim 3, wherein the fluid includes one of: a lubricant and air.

5. The blade of claim 1, wherein the blade further comprises a coating on at least one of the two surfaces configured to prevent fracture of the substrate.

6. The blade of claim 1, wherein the blade further comprises a coating on at least one of the two surfaces configured to indicate a wear status of the blade.

7. The blade of claim 6, wherein the coating provides a visible indication when the blade exceeds its operating life.

8. The blade of claim 7, wherein the visible indication includes changing a color of the coating.

9. The blade of claim 1, wherein the substrate further includes a monitoring mechanism configured to sense one of: a presence of moisture and a hardness of a material the blade is cutting.

10. The blade of claim 1, wherein, at the given location, the angle changes from the cutting edge to a base of the substrate that is distal from the cutting edge.

11. The blade of claim 1, wherein the angles are associated with one angle category in a set of N potential angle categories for the blade; and
wherein N is an integer.

12. The blade of claim 1, wherein the cutting edge includes a cutting pattern along the length of the blade.

13. The blade of claim 1, wherein a position of the cutting edge deviates from a plane to define a two-dimensional spatial pattern.

14. A cutting device, comprising:
a handle; and
a blade mechanically coupled to the handle, wherein the blade includes:
a substrate having two surfaces that meet at a cutting edge of the blade, wherein, at a given location along a length of the cutting edge, the two surfaces are at an angle with respect to one another; and
wherein angles between the two surfaces are different at at least two locations along the length of the blade.

15. The cutting device of claim 14, wherein the mechanical coupling is remateable.

16. The cutting device of claim 14, wherein the cutting device further comprises a motor configured to rotate the blade around an axis of the motor.

17. The cutting device of claim 14, wherein the angles vary periodically along the length of the blade.

18. The cutting device of claim 14, wherein the blade further comprises islands having top surfaces positioned at other locations along the length of the blade;
wherein the islands protrude above the cutting edge to protect skin of a user when the blade is used to cut hair; and
wherein the islands include fluidic channels configured to provide a fluid at the top surfaces of the islands when the blade is used.

19. The cutting device of claim 14, wherein the blade further comprises a coating on at least one of the two surfaces configured to indicate a wear status of the blade.

20. A method for cutting an object, wherein the method comprises:
positioning a cutting edge of a blade in at least partial mechanical contact with a surface of the object, wherein the blade includes a substrate having two surfaces that meet at the cutting edge of the blade, wherein, at a given location along a length of the cutting edge, the two surfaces are at an angle with respect to one another, and wherein angles between the two surfaces are different at at least two locations along the length of the blade; and
displacing the blade along the surface of the object while maintaining the at least partial mechanical contact.
